(19) United States
(12) Patent Application Publication
(10) Pub. No.: US 2018/0164186 A1
(43) Pub. Date: Jun. 14, 2018

(54) METHOD OF PREVENTING CATALYST FROM BEING DAMAGED THROUGH IGNITION TIMING CORRECTION

(71) Applicants: Hyundai Motor Company, Seoul (KR); Kia Motors Corporation, Seoul (KR)

(72) Inventor: Yong Sik KIM, Suwon-si (KR)

(73) Assignees: Hyundai Motor Company, Seoul (KR); Kia Motors Corporation, Seoul (KR)

(21) Appl. No.: 15/628,370

(22) Filed: Jun. 20, 2017

(30) Foreign Application Priority Data
Dec. 14, 2016 (KR) 10-2016-0170216

(51) Int. Cl. G01M 15/11; F02D 37/02; G01M 15/08; G01M 15/10; F01N 3/20

(52) U.S. Cl. CPC G01M 15/11; F02D 37/02; F02P 5/103; G01M 15/106; F01N 3/20; G01M 15/08

(57) ABSTRACT

A method of preventing a catalyst from being damaged through igniting timing correction may include confirming a number of engine revolutions, determining whether a misfire occurs; confirming a driving condition of a vehicle when the misfire occurs, determining an ignition timing correction efficiency based on the vehicle driving condition, and determining a misfire rate by determining and confirming a misfire effect of a cylinder based on the determined ignition timing correction efficiency

### CROSS-REFERENCE TO RELATED APPLICATION

The present application claims priority to Korean Patent Application No. 10-2016-0170216, filed on Dec. 14, 2016, the entire contents of which is incorporated herein for all purposes by this reference.

### BACKGROUND OF THE INVENTION

### Field of the Invention

The present invention relates to a method of preventing a catalyst from being damaged through ignition timing correction, and more particularly, to a method of preventing a catalyst from being damaged through ignition timing correction by detecting a misfire rate based on an ignition timing correction efficiency and a misfire effect of a cylinder.

### Description of Related Art

In general, the ignition timing of an internal combustion engine is controlled to increase engine torque or reduce exhaust gas, based on the number of engine revolutions and an engine load.

In this connection, a system for controlling engine ignition timing according to the related art includes a revolutions-per-minute (RPM) sensor configured to detect the number of engine revolutions, an intake air pressure sensor configured to detect an intake air pressure, an intake air temperature sensor configured to detect a temperature of intake air, an electronic control unit (ECU) configured to receive signals from sensors to determine an ignition timing and generate an ignition signal corresponding to the ignition timing, and an ignition device configured to receive the ignition signal from the ECU to ignite a fuel-air mixture.

When a predetermined time period is elapsed after engine ignition, the ECU calculates an ignition timing based on an RPM, an intake air pressure, and an intake air temperature and transfers a corresponding ignition signal to the ignition device such that the combustion process of a combustion chamber is controlled.

In this case, the ignition timing control is performed based on a map of default ignition timing stored in a memory equipped in the ECU, where the map of default ignition timing has default ignition timing values mapped with RPMs and engine loads as parameters.

When an actual RPM and an engine load are detected and a corresponding signal is input to the ECU, the ECU determines a default ignition timing based on the map of default ignition timing. In general, under condition of an engine idle and a partial load, the default ignition timing is determined as a value near at the minimum spark advance for best torque (MBT) for maximizing the engine power.

Meanwhile, a misfire, which is abnormal combustion in a cylinder of an engine, may occur. Such a misfire causes an incomplete combustion gas to be generated and the incomplete combustion gas is oxidized by a catalyst, so that the catalyst temperature is increased. Thus, if a number of misfires continuously occur, the catalyst and the engine may be damaged.

Therefore, according to the related art, the misfire rate is checked based on whether the catalyst temperature reaches a reference temperature (1,000° C.), where an element of determining the catalyst temperature is the sum of a chemical calorie in a misfired cylinder and a chemical calorie in a normal cylinder.

In this case, the calorie of the catalyst temperature is calculated as following Equation 1.

Q_{cat}=Q_{misfire}+Qₙₒᵣₘ [Equation 1]

Wherein Q_{cat} is a calorie of a catalyst temperature, Q_{misfire} is a calorie of a misfire cylinder, and Qₙₒᵣₘ is a calorie of exhaust gas of a normal cylinder. The calorie of the misfire cylinder is proportional to a quantity of fuel, and the calorie of exhaust gas of a normal cylinder is determined by a thermal efficiency under driving condition.

However, according to the related art, when the calorie of exhaust gas of a normal cylinder is changed under the same driving condition, a difference between the misfire rate and an allowable misfire rate occurs. When the calorie of exhaust gas of a normal cylinder is excessive, the misfire rate is lowered at the reference temperature, so that the misfire detection deteriorates.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a method of preventing a catalyst from being damaged through ignition timing correction. There is provided a method of preventing a catalyst from being damaged by determining an ignition timing correction efficiency and a misfire effect of a cylinder under vehicle driving condition to detect a misfire rate when the calorie of exhaust gas of a normal combustion cylinder is excessive.

The technical problems to be solved by the present inventive concept are not limited to the aforementioned problems, and any other technical problems not mentioned herein will be clearly understood from the following description by those skilled in the art to which the present invention pertains.

According to various aspects of the present invention, there is provided a method of preventing a catalyst from being damaged through igniting timing correction. The method includes confirming a number of engine revolutions, determining whether a misfire occurs after the confirming of the number of engine revolutions, confirming a driving condition of a vehicle when the misfire occurs, determining an ignition timing correction efficiency based on the driving condition, and determining a misfire rate by determining and confirming a misfire effect of a cylinder based on the determined ignition timing correction efficiency.

The determining of the ignition timing correction efficiency includes confirming an ignition timing efficiency based on an ignition timing mapping table memorized in an electronic control unit (ECU) of the vehicle, confirming an ignition timing efficiency of a current cylinder, and determining the ignition timing correction efficiency by determining a difference between the ignition timing efficiency based on the ignition timing mapping table and the ignition timing efficiency of the current cylinder.

The determining of the ignition timing correction efficiency further includes determining a weight of the determined ignition timing correction efficiency.

The determining of the misfire rate includes determining the misfire effect of the cylinder in which the misfire occurs, based on the determined weight, accumulating the misfire effect of the cylinder, and determining the misfire rate by accumulating misfire effects of all cylinders.

The method further includes determining whether the number of engine revolutions reaches 200 rpm after the determining of the misfire rate by the accumulating of the misfire effects is performed or when it is determined that the misfire does not occur, in the determining of whether the misfire occurs.

The method further includes determining whether the misfire effect confirmed in the determining of the misfire rate by the accumulating of the misfire effects is greater than a threshold value.

The method further includes turning on a malfunction indicator lamp when the misfire effect confirmed in the determining of the misfire rate by the accumulating of the misfire efficiencies is greater than the threshold value.

The number of engine revolutions is set to 200 rpm.

The driving condition includes revolutions per minute (RPM) of an engine, an engine load, an ignition timing, and an optimal ignition timing (MBT_spark).

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a flowchart illustrating a method of preventing a catalyst from being damaged through ignition timing correction, according to an exemplary embodiment of the present invention;

FIG. 2 is a flowchart illustrating in detail an ignition timing correction efficiency operation in a method of preventing a catalyst from being damaged through ignition timing correction, according to an exemplary embodiment of the present invention;

FIG. 3A and FIG. 3B are graphs illustrating a relation between an ignition timing delay and a catalyst damage misfire rate according to an exemplary embodiment of the present invention; and

FIG. 4 is a graph illustrating an ignition timing efficiency to a degree of an ignition timing delay, according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

Hereinafter, embodiments of the present invention will be described in detail with reference to the accompanying drawings.

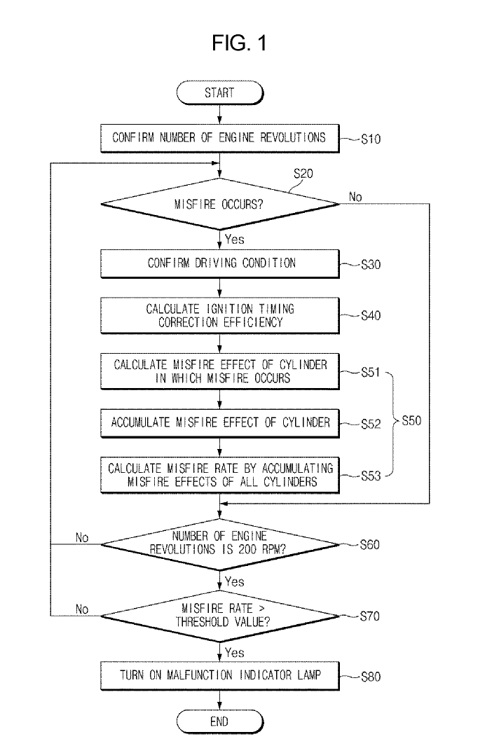

FIG. 1 is a flowchart illustrating a method of preventing a catalyst from being damaged through ignition timing correction, according to an exemplary embodiment of the present invention.

As illustrated in FIG. 1, a method according to an exemplary embodiment of the present invention includes the operations of: confirming the number of engine revolutions, determining whether a misfire occurs, confirming a driving condition, determining an ignition timing correction efficiency, and determining a misfire effect of a cylinder.

In operation S10, the number of engine revolutions is confirmed.

The number of engine revolutions is set to 200 rpm such that a misfire may be detected within 200 rpm immediately after an engine is operated.

In operation S20, it is determined whether the misfire occurs in a cylinder, after operation S10.

In the instant case, a variation of a rotation speed of a crack shaft is detected through an on-board diagnostics (OBD) or an electronic control unit (ECU) such that it is determined whether the misfire occurs.

In operation S30, when the misfire occurs, the vehicle driving condition is confirmed and data for compensating the ignition timing efficiency are collected in operation S40 to be described below.

The driving condition of operation S30 may include revolutions per minute (RPM) of an engine, an engine load, an ignition timing (Minimum spark advance for Best Torque (MBT)), and an optimal ignition timing (MBT_spark).

In operation S40, the ignition timing efficiency is determined based on the driving condition confirmed in operation S30.

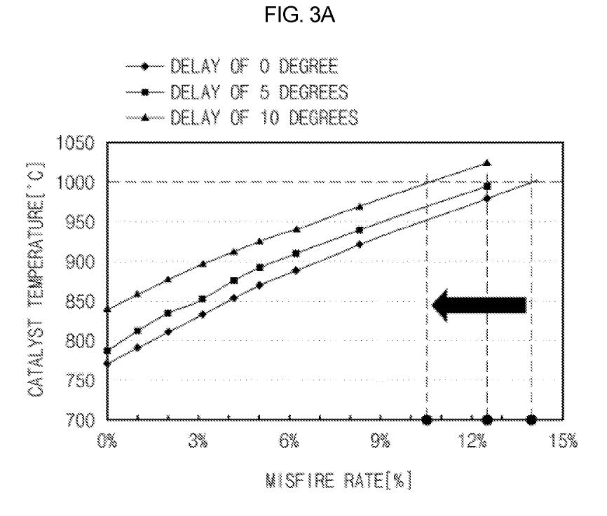

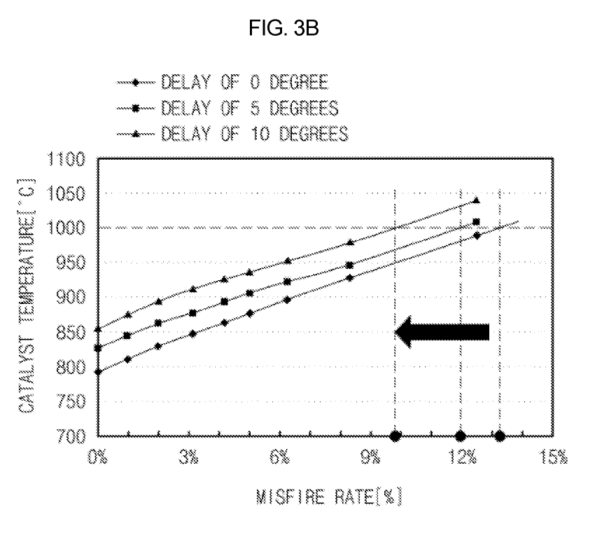

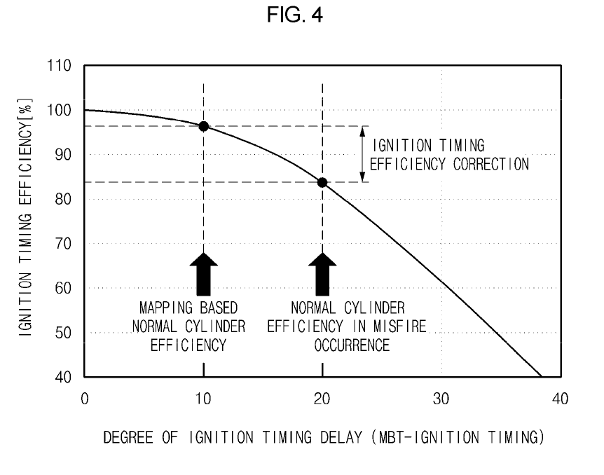

Meanwhile, as illustrated in the graphs of FIG. 3A and FIG. 3B, since the catalyst temperature is high at the same misfire rate and the catalyst temperature is increased when the ignition timing is delayed, it is required to reduce a catalyst damage misfire rate. In addition, as illustrated in the graph of FIG. 4, since the ignition timing efficiency is reduced when the ignition timing is delayed and the ignition timing correction is required, the ignition timing efficiency may be compensated to detect the misfire rate.

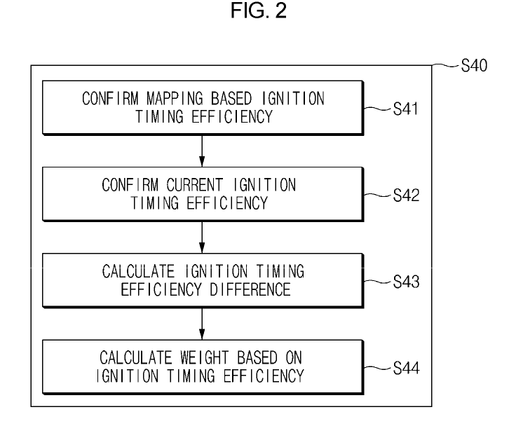

As illustrated in FIG. 2, operation S40 includes operation S41 of confirming the ignition timing efficiency based on an ignition timing mapping table memorized in the ECU of the vehicle to determine the ignition timing efficiency, operation S42 of confirming the ignition timing efficiency of a current cylinder, and operation S43 of determining an ignition timing correction efficiency. In the instant case, as illustrated in FIG. 4, the ignition timing efficiency is confirmed based on a degree of an ignition timing delay through a default value set in the ECU.

The ignition timing efficiency of operation S41 is determined as following Equation 2.

REF=MAP_1(Rpm,Load) [Equation 2]

Wherein ‘REF’ is a mapping table based ignition timing efficiency, ‘Rpm’ and ‘Load’ are revolutions per minute and an engine load. That is, the mapping table based ignition timing efficiency may be confirmed based on the revolutions per minute and the engine load. In this case, ‘MAP_1’ is a reference value confirmed based on ‘Rpm’ and ‘Load’ and is determined based on the set table values.

In operation S42, the ignition timing efficiency of the current cylinder in which a misfire occurs is determined as following Equation 3.

ACT=MAP_2(MBT_Spark−Ignition timing) [Equation 3]

Wherein ‘ACT’ is an ignition timing efficiency of a current cylinder and is calculated based on a difference between the optimal ignition timing (MBT_spark) and the ignition timing (MBT). In this case, ‘MAP_2’ is a reference value confirmed based on the optimal ignition timing and the ignition timing and is calculated based on the set table values.

In operation S43, the ignition timing correction efficiency is determined as following Equation 4.

D_EFF=REF_EFF−ACT_EFF [Equation 4]

Wherein ‘D_EFE’ is the ignition timing correction efficiency and is calculated based on a difference between the mapping table based ignition timing efficiency (REF_EFF) and the ignition timing efficiency (ACT_EFF) of a current engine.

In addition, operation S40 further includes operation S44 of determining a weight of the ignition timing correction efficiency determined in operation S43.

In operation S44, the weight of the ignition timing correction efficiency is determined as following Equation 5.

WF=MAP_3(D_EFF) [Equation 5]

Wherein ‘WP’ is the weight of the ignition timing efficiency and is calculated based on the ignition timing correction efficiency calculated in operation S43. In this case, ‘MAP_3’ is a reference value confirmed based on the ignition timing correction efficiency and is calculated based on the set table values.

As described above, in operation S50, the misfire effect of the cylinder is determined and confirmed based on the ignition timing correction efficiency determined in operation S40 to determine the misfire rate.

Operation S50 includes operation S51 of determining the misfire effect of the cylinder, in which a misfire occurs, based on the weight determined in operation S44 to determine the misfire rate, operation S52 of accumulating the misfire effect of the cylinder, and operation S53 of determining the misfire rate by accumulating the misfire efficiencies of all cylinders.

In operation S51, the misfire effect of the cylinder is determined as following Equation 6.

K=Ck(Rpm,Load)*WF [Equation 6]

Wherein ‘K’ represents a misfire effect of a cylinder in which a misfire occurs, and the misfire rate is calculated by multiplying the misfire value Ck of the cylinder based on the number of engine revolutions (rpm) and the engine load by the weight of the ignition timing correction efficiency.

In operation S52, the accumulated misfire effect of the cylinder is determined as following Equation 7.

CNT[cyl]=CNT[cyl]+K [Equation 7]

Wherein ‘CNT[cyl]’ is the accumulated misfire effect (counter) of a corresponding cylinder and is calculated by adding one misfire effect of the corresponding cylinder to another misfire effect.

In operation S53, the accumulated misfire effect of all cylinders is determined as following Equation 8.

Total_CNT=ΣCNT[cyl] [Equation 8]

Wherein ‘Total_CNT’ is the accumulated misfire effect (counter) of all the cylinders and is calculated by accumulating the misfire effect of each cylinder.

Meanwhile, it is determined in operation S60 whether the number of engine revolutions reaches 200 rpm, and the number of engine revolutions is confirmed after operation S53 is performed or when the misfire does not occur in operation S20.

In addition, when the number of engine revolutions reaches 200 rpm in operation S60, the process goes to a next operation. When the number of engine revolutions is less than 200 rpm, the process goes to operation S20 such that it is determined again whether a misfire occurs.

In operation S70, when the number of engine revolutions is 200 rpm or more as the result of operation S60, it is determined whether the misfire effects of all the cylinders is greater than a predetermined threshold value. In operation S80, when it is determined in operation S70 that the misfire effects of all the cylinders are greater than the predetermined threshold value, a malfunction indicator lamp (MIL) is turned on.

That is, even though a misfire is detected before the number of engine revolutions reaches 200 rpm, the misfire may be accumulated. When the number of engine revolutions reaches 200 rpm and the misfire effect exceeds the threshold value, it is determined that the misfire occurs and a driver may be informed of the misfire through the MIL.

As described above, the method of preventing a catalyst from being damaged according to an exemplary embodiment of the present invention includes operation S10 of confirming the number of engine revolutions, operation S20 of determining whether a misfire occurs, operation S30 of confirming a driving condition of a vehicle when the misfire occurs, operation S40 of determining an ignition timing correction efficiency based on the vehicle driving condition, and operation S50 of determining a misfire rate by determining and confirming a misfire effect based on the determined ignition timing correction efficiency. Thus, when a misfire occurs, the ignition timing correction efficiency and the misfire effect of a cylinder are determined to detect a misfire rate under the driving condition of the vehicle, such that a phenomenon of reducing a misfire occurrence diagnosis rate may be prevented and the accuracy and reliability of a misfire occurrence diagnosis may be improved.

As described above, according to an exemplary embodiment of the present invention, when a misfire occurs, an ignition timing correction efficiency and a misfire effect of a cylinder under vehicle driving condition are determined to detect a misfire rate, such that a phenomenon of reducing a misfire occurrence diagnosis rate may be prevented and the accuracy and reliability of a misfire occurrence diagnosis may be improved, improving the marketability.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method of preventing a catalyst from being damaged through ignition timing correction, the method comprising:
confirming by an electronic control unit (ECU), a number of engine revolutions;
determining whether a misfire occurs after the confirming of the number of the engine revolutions;
confirming a driving condition of a vehicle when the misfire occurs;
determining an ignition timing correction efficiency based on the driving condition; and
determining a misfire rate by determining and confirming a misfire effect of a cylinder based on the determined ignition timing correction efficiency.

2. The method of claim 1, wherein the determining of the ignition timing correction efficiency includes:
confirming an ignition timing efficiency based on an ignition timing mapping table memorized in the ECU of the vehicle;
confirming an ignition timing efficiency of a current cylinder; and
determining the ignition timing correction efficiency by determining a difference between the ignition timing efficiency based on the ignition timing mapping table and the ignition timing efficiency of the current cylinder.

3. The method of claim 2, wherein the determining of the ignition timing correction efficiency further includes:
determining a weight of the determined ignition timing correction efficiency.

4. The method of claim 3, wherein the determining of the misfire rate includes:
determining the misfire effect of the cylinder in which the misfire occurs, based on the determined weight;
accumulating the misfire effect of the cylinder; and
determining the misfire rate by accumulating misfire effects of all cylinders.

5. The method of claim 4, further comprising:
determining whether the number of engine revolutions reaches a predetermined RPM after the determining of the misfire rate by the accumulating of the misfire effects is performed or when it is determined that the misfire does not occur, in the determining of whether the misfire occurs.

6. The method of claim 4, wherein predetermined RPM is about 200 RPM.

7. The method of claim 6, further comprising:
determining whether the misfire effect confirmed in the determining of the misfire rate by the accumulating of the misfire effects is greater than a threshold value.

8. The method of claim 7, further comprising:
turning on a malfunction indicator lamp when the misfire effect confirmed in the determining of the misfire rate by the accumulating of the misfire effects is greater than the threshold value.

9. The method of claim 1, wherein the number of engine revolutions is set to about 200 rpm.

10. The method of claim 1, wherein the driving condition includes revolutions per minute (RPM) of an engine, an engine load, an ignition timing, and an optimal ignition timing (MBT_spark).
